(19) United States
(12) Patent Application Publication
(10) Pub. No.: US 2014/0225375 A1
(43) Pub. Date: Aug. 14, 2014

(54) POWER SUPPLY DEVICE FOR DOOR HANDLE

(71) Applicant: Yu Hsiang Chang, Taichung City (TW)

(72) Inventor: Yu Hsiang Chang, Taichung City (TW)

(21) Appl. No.: 13/767,584

(22) Filed: Feb. 14, 2013

(51) Int. Cl. H02K 57/00

(52) U.S. Cl. CPC H02K 57/003
USPC 290/1 C

(57) ABSTRACT

A power supply device for a door handle is provided. A rotation shaft of the door handle is provided with a drive gear, a first speed-change gear, a second speed-change gear, and a generator. Two end of a rotation shaft of the generator are respectively provided with a gravity wheel and a freewheel. The freewheel has one-way teeth, a link plate with link teeth and a third speed-change gear. The third speed-change gear meshes with the second speed-change gear. When the door handle is turned to an angle, the drive gear, the first and second speed-change gears, the third speed-change gear and the freewheel are driven to turn so that the rotation shaft of the generator is turned to generate power for an electric lock (such as a fingerprint lock, a coded lock, a chip induction lock).

### BACKGROUND OF THE INVENTION

1. Field of the Invention

The present invention relates to a power supply device for a door handle, and more particularly, to a power supply device by turning the door handle to generate power for an electric lock. The power supply device can prolong the time to generate power for the user to lock or unlock the electric lock, without using the power source of the electric power company or a battery. The power supply device can supply power to an illuminating light or a burglar alarm.

2. Description of the Prior Art

In general, a door or a safe is provided with an electric lock, such as a fingerprint lock, a coded lock or a chip induction lock. The electric lock needs power to control and drive a latch to lock or unlock the door. The conventional electric lock uses the power source of the electric power company or a battery. The former has the following shortcomings: (1) The electric lock needs piping and electric wires. When building a house, it is necessary to plan the piping and electric wires in advance, otherwise external piping and electric wires mounted on the wall will destroy beauty. (2) If there is a power failure or a fire accident, the electric lock cannot be unlocked. The latter has the following shortcomings: (1) When the battery has run down, it is unable to unlock the door. (2) The battery is unable to endure a high temperature, a fir accident will cause the electric lock cannot be unlocked.

Accordingly, the inventor of the present invention has devoted himself based on his many years of practical experiences to solve these problems.

### SUMMARY OF THE INVENTION

The primary object of the present invention is to provide a power supply device for a door handle to improve the shortcoming of the prior art. A rotation shaft of the door handle is provided with a drive gear, a generator, a first speed-change gear and a second speed-change gear. The rear end of a rotation shaft of the generator is provided with a gravity wheel. The front end of the rotation shaft of the generator is provided with a freewheel and a third speed-change gear. The freewheel has one-way teeth. The third speed-change gear has a link plate with link teeth. The third speed-change gear, the second speed-change gear and the drive gear mesh with one another. When the door handle is turned, the drive gear, the first speed-change gear, the second speed-change gear, the third speed-change gear, the link teeth of the link plate and the freewheel are driven to turn so that the generator is activated to generate power for an electric lock. The present invention doesn't need to use the power source of the electric power company or a battery so there is no need to worry about a power failure or to worry that the battery has run down.

The rotation shaft of the generator of the present invention is provided with the freewheel and the gravity wheel. The freewheel has the one-way teeth. When the link teeth of the link plate mesh with the one-way teeth of the freewheel, the freewheel and the gravity wheel will be turned. The gravity wheel is turned to generate gravitational acceleration and to have the effect of inertial rotation, the rotation shaft of the generator prolongs the rotation time, namely, to prolong the time to generate power to supply enough power for the user to lock or unlock the electric lock. The present invention can be connected with an illuminating light or a burglar alarm.

### BRIEF DESCRIPTION OF THE DRAWINGS

FIG. 1 is an exploded view of the present invention;

FIG. 2 is an assembled view of the present invention;

FIG. 3 is a top sectional view of the present invention;

FIG. 4 is a front sectional view of the present invention;

FIG. 5 is a schematic view of the present invention applied to a fingerprint lock;

FIG. 6 is a schematic view of the present invention applied to a coded lock; and

FIG. 7 is a schematic view of the present invention applied to a fingerprint lock and a coded lock.

### DETAILED DESCRIPTION OF THE PREFERRED EMBODIMENTS

Embodiments of the present invention will now be described, by way of example only, with reference to the accompanying drawings.

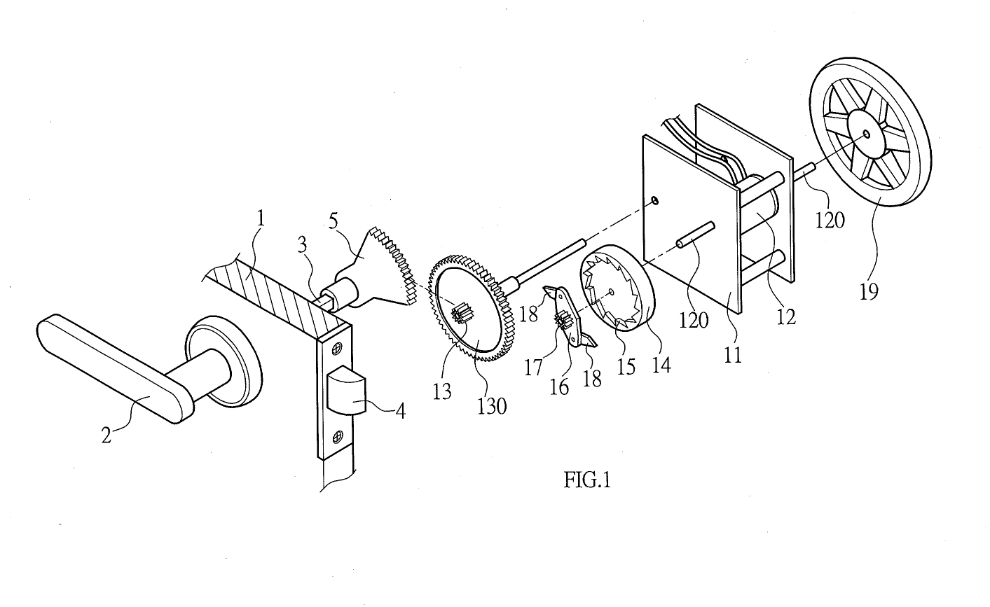

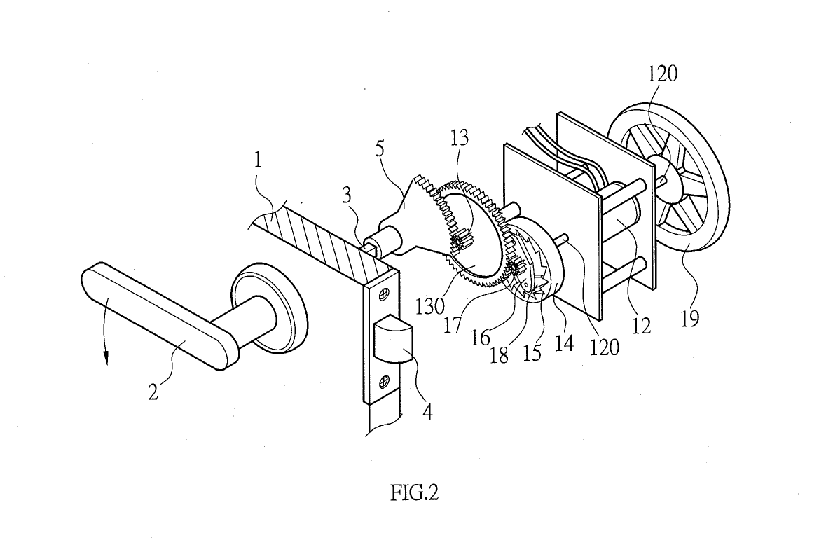

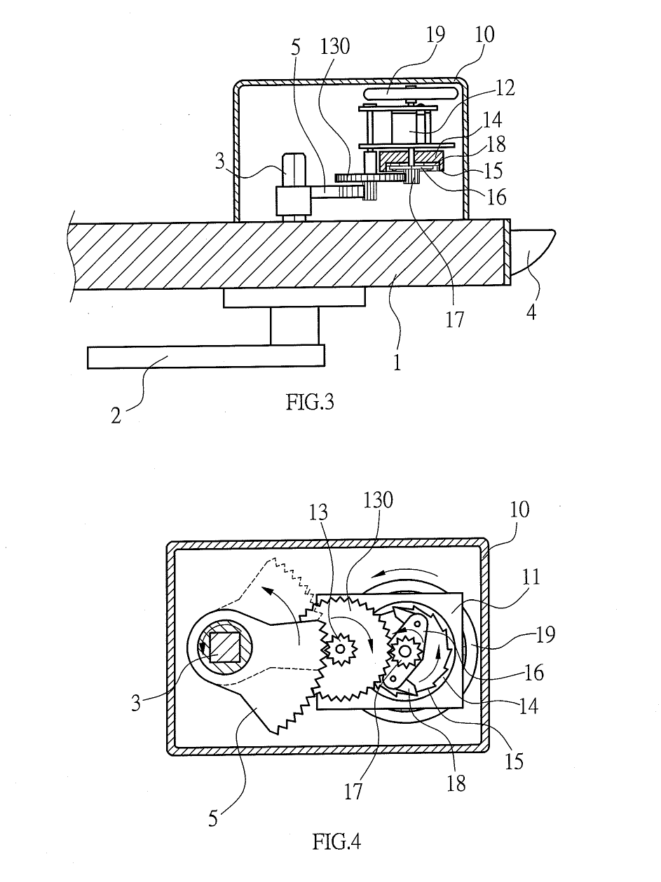

As shown in FIG. 1, FIG. 2, FIG. 3 and FIG. 4, the present invention comprises a drive gear 5 disposed on a rotation shaft 3 of a door handle 2, a fixing seat 11 provided with a generator 12, and a casing 10 fixed to a door 1. The fixing seat 11 is provided with a first speed-change gear 13 and a second speed-change gear 130. The first speed-change gear 13 meshes with the drive gear 5. The rear end of a rotation shaft 120 of the generator 12 is provided with a gravity wheel 19. The front end of the rotation shaft 120 of the generator 12 is provided with a freewheel 14. The freewheel 14 has one-way teeth 15 arranged in a circle. A link plate 16 is provided among the one-way teeth 15 of the freewheel 14. Two ends of the link plate 16 are provided with retractable and extendable link teeth 18. When the link teeth 18 extend to mesh with the one-way teeth 15 of the freewheel 14, the freewheel 14 is driven to turn. The link plate 16 comprises a third speed-change gear 17 at a central portion thereof to mesh with the second speed-change gear (130).

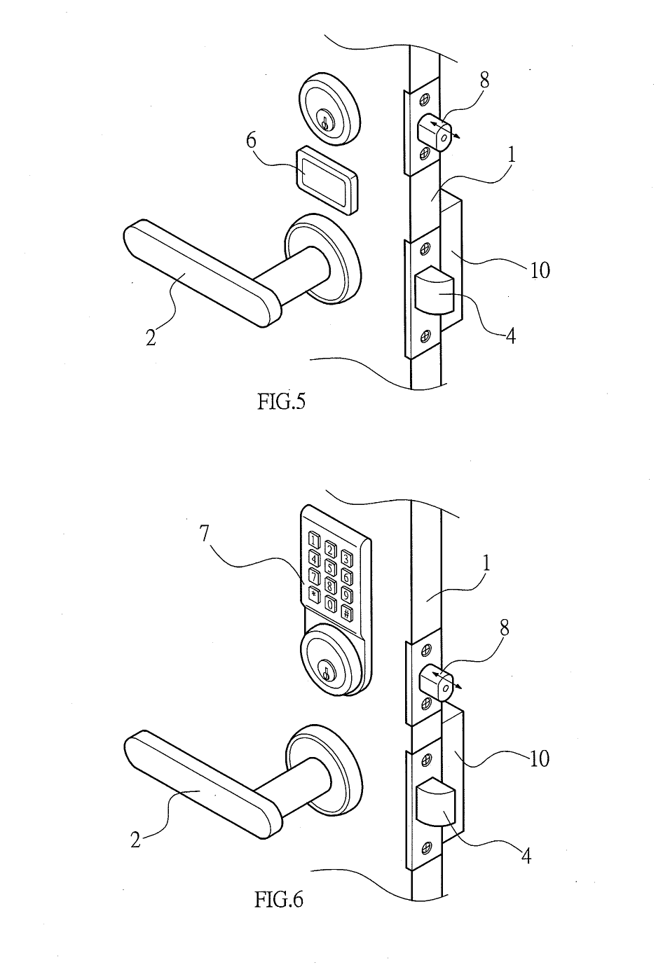

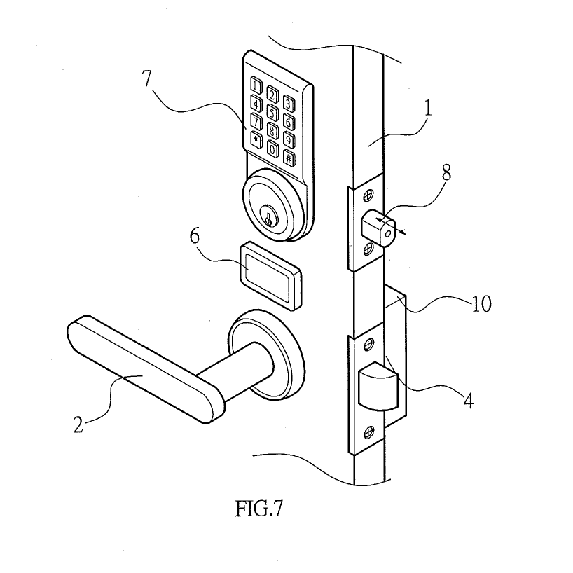

According to the aforesaid device, when the door handle 2 is turned to move a latch 4, the rotation shaft 3 of the door handle 2 will be driven to turn the drive gear 5. As shown in FIG. 3 and FIG. 4, the first and second speed-change gears 13, 130, the third speed-change gear 17 and the link plate 16 are turned, and the link teeth 18 of the link plate 16 extend to mesh with the one-way teeth 15 of the freewheel 14 so that the freewheel 14 is turned. The rotation shaft 120 of the generator 12 is turned to generate power for an electric lock. The electric lock, as shown in FIG. 5, FIG. 6 and FIG. 7, may be a fingerprint lock 6 or a coded lock 7. The fingerprint lock 6 and the coded lock 7 have electricity to lock or unlock a lock latch 8. The present invention can be applied to a lock with a chip sensor or a card sensor.

Furthermore, the present invention can prolong the time to generate power. As shown in FIG. 3 and FIG. 4, when the rotation shaft 3 of the door handle 2 is turned to an angle (about 45 degrees), the drive gear 5 is turned to turn the first speed-change gear 13 at a high speed, and then the second speed-change gear 130 is turned to turn the third speed-change gear 17 to increase the rotation speed so that the freewheel 14 is turned at a high speed. The prevent invention is provided with the gravity wheel 19. After the gravity wheel 19 is turned to generate gravitational acceleration and to have the effect of inertial rotation, the rotation shaft 120 of the generator 12 prolongs its rotation time, namely, to prolong the time to generate power. Besides, the link teeth 18 of the link plate 16 are extendable and retractable. After the link teeth 18 of the link plate 16 mesh with the one-way teeth 15, the freewheel 14 is turned at a high speed to disengage the link teeth 18 from the one-way teeth 15. This can prevent the link teeth 18 from interfering rotation of the freewheel 14. That is to say, the link teeth 18 won't consume the rotational power of the freewheel 18 so as to prolong the rotation time of the rotation shaft 120 of the generator 12. The rotation time is more than 15 seconds to supply enough power for the user to lock or unlock the electric lock.

The present invention can be connected with an illuminating light or a burglar alarm. The illuminating light supplies light to illuminate the key hole to unlock the electric lock. The burglar alarm provides a burglarproof effect when the door handle is turned by a burglar.

Accordingly, the present invention doesn't need to use the power source of the electric power company or a battery, so there is no need to worry about a power failure or to worry that the battery has run down. The door handle is turned to a certain angle to supply enough power for the user to operate the electric lock. The present invention is very practical.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A power supply device for a door handle, comprising a drive gear disposed on a rotation shaft of the door handle, a fixing seat provided with a generator, and a casing fixed to a door, the fixing seat being provided with a first speed-change gear and a second speed-change gear, the first speed-change gear meshing with the drive gear, a rear end of a rotation shaft of the generator being provided with a gravity wheel, a front end of the rotation shaft of the generator being provided with a freewheel, the freewheel having one-way teeth arranged in a circle, a link plate being provided among the one-way teeth of the freewheel, two ends of the link plate being provided with link teeth, the link teeth being extendable to mesh with the one-way teeth of the freewheel so that the freewheel is driven to turn, the link plate comprising a third speed-change gear at a central portion thereof to mesh with the second speed-change gear, wherein, when the door handle is turned to an angle, the drive gear, the first speed-change gear, the second speed-change gears, the third speed-change gear and the link plate are driven to turn, the link teeth of the link plate extend to mesh with the one-way teeth of the freewheel so that the freewheel is turned and the rotation shaft of the generator is turned to generate power for an electric lock, when the rotation shaft of the generator is turned, the gravity wheel is driven to turn, the gravity wheel is turned to generate inertial rotation so that the rotation shaft of the generator prolongs rotation time so as to prolong the time to generate power.
